(19) United States
(12) Patent Application Publication
(10) Pub. No.: US 2010/0244782 A1
(43) Pub. Date: Sep. 30, 2010

(54) CHARGING CONTROL DEVICE AND METHOD, CHARGING DEVICE, AS WELL AS PROGRAM

(75) Inventors: Keiichi Nagayama, Aichi-gun (JP); Hiroyuki Sueyasu, Kasugai-shi (JP); Yusaku Ido, Kani-shi (JP); Naoki Hirobe, Kasugai-shi (JP); Koji Hachiya, Kasugai-shi (JP); Hiroshi Nakao, Kawasaki-shi (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shi (JP)

(21) Appl. No.: 12/713,969

(22) Filed: Feb. 26, 2010

(30) Foreign Application Priority Data
Mar. 2, 2009 (JP) 2009-047596

(51) Int. Cl. H02J 7/04

(52) U.S. Cl. 320/162; 180/65.29

(57) ABSTRACT

A battery state monitoring portion intermittently monitors the low voltage battery for supplying power to electrical components arranged in a vehicle while the power supply to the low voltage system load other than a +B load is stopped, a DCDC converter is stopped, and a +B power supply mode in which the vehicle cannot travel is set. A charging control portion starts up the DCDC converter and charges the low voltage battery with the power of a high voltage battery as a power source of the vehicle through the DCDC converter when the voltage of the low voltage battery becomes lower than or equal to a charging start voltage when the +B power supply mode is set. The present invention can be applied to a charging device of a battery of an electric vehicle.

### BACKGROUND OF THE INVENTION

1. Technical Field

The present invention relates to charging control devices and methods, charging devices, as well as, programs, and in particular, to a charging control device and method, a charging device, as well as, a program suitably used to charge a battery of an electric vehicle.

2. Related Art

An electric vehicle such as an EV (Electric Vehicle), an HEV (Hybrid Electric Vehicle), and a PHEV (Plug-in Hybrid Electric Vehicle) includes two types of batteries, a high voltage battery of between 158 VDC and 334 VDC and a low voltage battery of 12 VDC.

The high voltage battery is mainly used as a power supply for a large power load (hereinafter referred to as high voltage system load) such as a main power motor for driving and traveling the wheels of the electric vehicle, and a compressor motor of an A/C (air conditioner). The low voltage battery is mainly used for a medium and small power load (hereinafter referred to as low voltage system load) such as various types of ECU (Electronic Control Unit), a motor for a power window, and an illumination lamp.

The low voltage battery is charged by converting (voltage dropping) the voltage of the high voltage battery by a DCDC converter and supplying the same (see e.g., Japanese Unexamined Patent Publication No. 6-78408).

### SUMMARY

If the electric vehicle is left parking for a long period, the power of the low voltage battery is consumed by dark current, and the low voltage battery may run out. If the low voltage battery runs out, the ECU (Electronic Control Unit) for controlling the charging of the battery does not operate, whereby the low voltage battery cannot be charged with the power of the high voltage battery, and the electric vehicle may not be able to travel. A need to first charge the low voltage battery with some kind of method arises, which becomes inconvenient to the user.

However, the countermeasures for such a problem are not reviewed in the invention described in Japanese Unexamined Patent Publication No. 6-78408.

One or more embodiments of the present invention reliably prevent the low voltage battery from running out.

### BRIEF DESCRIPTION OF THE DRAWINGS

FIG. 1 is a block diagram showing one embodiment of an electrical system of an electric vehicle applying the present invention;

FIG. 2 is a block diagram showing an example of a configuration of the function of the low voltage battery charging control unit;

FIG. 3 is a flowchart describing the low voltage battery charging control process at the time of the +B power supply mode;

FIG. 4 is a view showing an example of the time-series transition of the SOC of the high voltage battery, the voltage of the low voltage battery, and the output current of the DCDC converter at the time of the +B power supply mode;

FIG. 5 is a flowchart describing the low voltage battery charging control process at the time of the ACC power supply mode;

FIG. 6 is a flowchart describing the low voltage battery charging control process at the time of the ACC power supply mode;

FIG. 7 is a view showing an example of the time-series transition of the SOC of the high voltage battery, the voltage of the low voltage battery, the output current of the DCDC converter, and the ACC load power supply tolerable current at the time of the ACC power supply mode; and

FIG. 8 is a flowchart describing the low voltage battery charging control process at the time of the IG power supply mode.

### DETAILED DESCRIPTION

Hereinafter, embodiments of the present invention will be described with reference to the drawings.

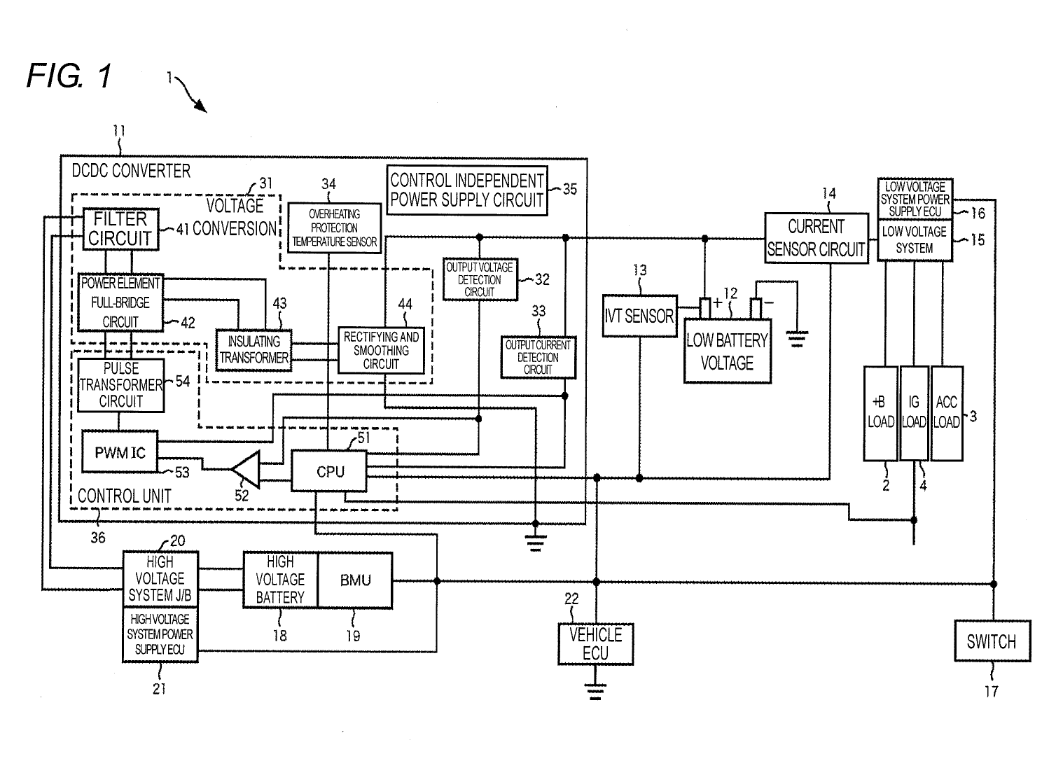

FIG. 1 is a block diagram showing one embodiment of an electrical system of a vehicle applying the present invention. The electrical system 1 of FIG. 1 shows the portion related to the supply of power to the low voltage system load, which is mainly an electrical component of low voltage (e.g., 12 V), of the electrical systems arranged in the electric vehicle that travels using the power accumulated in the battery such as an EV, an HEV, and a PHEV.

The low voltage system load includes various types of ECU (Electronic Control Unit), a motor for power window, an illumination lamp, and the like, and is classified into three systems of a +B load 2, an ACC (accessory) load 3, and an IG (ignition) load 4, as shown in FIG. 1. The vehicle including the electrical system 1 is hereinafter referred to as self-vehicle.

The electrical system 1 is configured to include a DCDC converter 11, a low battery voltage 12, an IVT sensor 13, a current sensor circuit 14, a low voltage system J/B (Junction Box) 15, a low voltage system power supply ECU (Electronic Control Unit) 16, a switch 17, a high voltage battery 18, a BMU (Battery Management Unit) 19, a high voltage system J/B (Junction Box) 20, a high voltage system power supply ECU (Electronic Control Unit) 21, and a vehicle ECU (Electronic Control Unit) 22.

The DCDC converter 11 is configured to include a voltage conversion unit 31, an output voltage detection circuit 32, an output current detection circuit 33, an overheating protection temperature sensor 34, a control independent power supply circuit 35, and a control unit 36.

The voltage conversion unit 31 converts the voltage of the power supplied from the high voltage battery 18 through the high voltage system J/B 20, and supplies the voltage to the low voltage battery 12 and the low voltage system J/B 15 based on the control of the control unit 36. The voltage conversion unit 31 is configured to include a filter circuit 41, a power element full-bridge circuit 42, an insulating transformer 43, and a rectifying and smoothing circuit 44.

The filter circuit 41 removes noise of the voltage supplied from the high voltage battery 18 through the high voltage system J/B 20, and supplies the same to the power element full-bridge circuit 42.

The power element full-bridge circuit 42 is configured by a full-bridge circuit that uses a power semiconductor switching element such as a transistor, a MOSFET (Metal-Oxide-Semiconductor Field-Effect Transistor), an IGBT (Insulated Gate Bipolar Transistor), and an IPM (Intelligent Power Module). The power element full-bridge circuit 42 converts a DC (Direct Current) voltage supplied from the high voltage battery 18 through the high voltage system J/B 20 to an AC (Alternating Current) voltage based on a switching signal provided from a pulse transformer circuit 54 of the control unit 36, and supplies the same to the insulating transformer 43.

The insulating transformer 43 insulates the input and the output of the DCDC converter 11, and transforms the AC voltage supplied from the power element full-bridge circuit 42 at a predetermined transformation ratio, and supplies the same to the rectifying and smoothing circuit 44.

One of the two output terminals of the rectifying and smoothing circuit 44 is connected to the plus terminal of the low voltage battery 12 and the low voltage system J/B 15, and the other output terminal is grounded. The rectifying and smoothing circuit 44 rectifies and smoothes the AC voltage supplied from the insulating transformer 43 to the DC voltage, and supplies the same to the low voltage battery 12 and the low voltage system J/B 15.

The output voltage detection circuit 32 detects the output voltage of the DCDC converter 11, and provides a signal indicating the detection value to a CPU 51 and an error amplifier 52 of the control unit 36.

The output current detection circuit 33 detects the output current of the DCDC converter 11, and provides a signal indicating the detection value to the CPU 51 and a PWM IC 53 of the control unit 36.

The overheating protection temperature sensor 34 detects the temperature of the DCDC converter 11, and provides a signal indicating the detection value to the CPU 51 of the control unit 36.

The control independent power supply circuit 35 generates a drive power of the control unit 36 from the power supplied from the high voltage battery 18 through the high voltage system J/B 20, and supplies the same to the control unit 36.

The control unit 36 is configured to include the CPU 51, the error amplifier 52, the PWM IC 53, and the pulse transformer circuit 54.

The CPU 51 acquires signals indicating the detection values of the voltage, the current, and the temperature of the low voltage battery 12 from an IVT sensor 13. The CPU 51 also acquires a signal indicating the detection value of the load current to the low voltage system load detected by the current sensor circuit 14. The CPU 51 controls the start and the stop of the output of the DCDC converter 11 and sets a target value (hereinafter referred to as target voltage) of the output voltage of the DCDC converter 11 based on the output voltage, the output current, and the temperature of the DCDC converter 11, the voltage, the current, and the temperature of the low voltage battery 12, and the load current to the low voltage system load. The CPU 51 provides a signal indicating the target voltage of the DCDC converter 11 to the error amplifier 52.

The error amplifier 52 amplifies the difference between the value of the signal from the output voltage detection circuit 32 and the value of the signal from the CPU 51, that is, the difference between the output voltage and the target voltage of the DCDC converter 11, and provides the same to the PWM IC 53.

The PWM IC 53 controls the duty ratio of the PWM (Pulse Width Modulation) signal provided to the pulse transformer circuit 54 and controls the start and the stop of the output of the pulse transformer circuit 54 so that the output voltage of the DCDC converter 11 becomes the target voltage based on the signal provided from the error amplifier 52.

The pulse transformer circuit 54 controls the output voltage of the DCDC converter 11 by providing a switching signal based on the PWM signal from the PWM IC 53 to the power element full-bridge circuit 42 and controlling the switching of the power element full-bridge circuit 42.

The low voltage battery 12 is connected between the output side of the DCDC converter 11, and the low voltage system load (+B load 2, ACC load 3, IG load 4) connected to the output side of the DCDC converter 11 via the low voltage system J/B 15. The low voltage battery 12 is charged by the power supplied from the high voltage battery 18 through the high voltage system J/B 20 and the DCDC converter 11, and supplies the power to the +B load 2, the ACC load 3, and the IG load 4 through the low voltage system J/B 15. The minus terminal of the low voltage battery 12 is grounded.

The IVT sensor 13 detects the voltage (e.g., voltage between the plus terminal and the minus terminal of the low voltage battery 12), the current, and the temperature of the low voltage battery 12. The IVT sensor 13 provides the signals indicating the detection values of the voltage, the current, and the temperature of the low voltage battery 12 to the low voltage system power supply ECU 16, the BMU 19, the high voltage system power supply ECU 21, the vehicle ECU 22, and the CPU 51 through the CAN (Controller Area Network).

The current sensor circuit 14 is arranged between the low voltage battery 12 and the low voltage system J/B 15, and detects the load current supplied from the DCDC converter 11 or the low voltage battery 12 to the low voltage system load through the low voltage system J/B 15. The current sensor circuit 14 provides the signal indicating the detection value of the load current to the low voltage system power supply ECU 16, the BMU 19, the high voltage system power supply ECU 21, the vehicle ECU 22, and the CPU 51 through the CAN.

The low voltage system J/B 15 incorporates a contact, a relay, and the like, and switches the presence of power supply to the +B load 2, the ACC load 3, and the IG load 4 based on the control of the low voltage system power supply ECU 16.

The switch 17 is configured by an ignition key switch, a starter switch, or both.

For instance, if the self-vehicle is configured by an HEV or a PHEV mounted with an engine for traveling or for charging the high voltage battery 18, the switch 17 can be set to four positions, LOCK or OFF (hereinafter unified as OFF), ACC (accessory), IG (ignition) or ON (hereinafter unified ON), and START.

In this case, when the position of the switch 17 is set to OFF, the self-vehicle cannot operate the engine and the main power motor, and cannot travel. The self-vehicle is in a state in which the power can only be supplied to the +B load 2 of the low voltage system load based on the control of the low voltage system power supply ECU 16.

When the position of the switch 17 is set to ACC, the self-vehicle cannot operate the engine and the main power motor, and cannot travel, similar to when set to OFF. The self-vehicle is in a state in which the power can be supplied to the +B load 2 and the ACC load 3 of the low voltage system load based on the control of the low voltage system power supply ECU 16.

Furthermore, when the position of the switch 17 is set to ON, the self-vehicle can operate the engine and the main power motor, and can travel. The self-vehicle is in a state in which the power can be supplied to all the low voltage system loads of the +B load 2, the ACC load 3, and the IG load 4 based on the control of the low voltage system power supply ECU 16.

When the position of the switch 17 is set to START, the engine of the self-vehicle is ignited and started. The self-vehicle is in a state in which the power can be supplied to all the low voltage system loads of the +B load 2, the ACC load 3, and the IG load 4 based on the control of the low voltage system power supply ECU 16. Depending on the type of vehicle, the power supply to the ACC load 3 is sometimes stopped to start the self-starter motor when the position of the switch 17 is set to START.

Thus, if the self-vehicle is configured by an HEV or a PHEV, the electrical system 1 can constantly supply power to the +B load 2 irrespective of the set position of the switch 17, supply power to the ACC load 3 when the position of the switch 17 is set to ACC, ON, or START, and supply power to the IG load 4 when the position of the switch 17 is set to ON or START.

If the self-vehicle is configured by an EV that is not mounted with the engine, the switch 17 can be set to three positions, LOCK or OFF (hereinafter unified as OFF), ACC (accessory), and START or ON (hereinafter unified ON).

In this case, when the position of the switch 17 is set to OFF, the self-vehicle cannot operate the engine and the main power motor, and cannot travel. The self-vehicle is in a state in which the power can only be supplied to the +B load 2 of the low voltage system load based on the control of the low voltage system power supply ECU 16.

When the position of the switch 17 is set to ACC, the self-vehicle cannot operate the engine and the main power motor, and cannot travel, similar to when set to OFF. The self-vehicle is in a state in which the power can be supplied to the +B load 2 and the ACC load 3 of the low voltage system load based on the control of the low voltage system power supply ECU 16.

Furthermore, when the position of the switch 17 is set to ON, the self-vehicle can operate the engine and the main power motor, and can travel. The self-vehicle is in a state in which the power can be supplied to all the low voltage system loads of the +B load 2, the ACC load 3, and the IG load 4 based on the control of the low voltage system power supply ECU 16.

Thus, if the self-vehicle is configured by an EV, the electrical system 1 can constantly supply power to the +B load 2 irrespective of the set position of the switch 17, supply power to the ACC load 3 when the position of the switch 17 is set to ACC or ON, and supply power to the IG load 4 when the position of the switch 17 is set to ON.

Hereinafter, a state in which the position of the switch 17 is set to LOCK or OFF and the power can be supplied only to the +B load 2, that is, a state in which the power can be supplied from the DCDC converter 11 or the low voltage battery 12 to the line of the +B load 2 through the low voltage system J/B 15 is referred to as +B power supply mode. A state in which the position of the switch 17 is set to ACC and the power can be supplied to the +B load 2 and the ACC load 3, that is, a state in which the power can be supplied from the DCDC converter 11 or the low voltage battery 12 to the line of the +B load 2 and the ACC load 3 through the low voltage system J/B 15 is referred to as ACC power supply mode. A state in which the position of the switch 17 is set to IG, ON, or START and the power can be supplied to all of the low voltage system loads of the +B load 2, the ACC load 3, and the IG load 4, that is, a state in which the power can be supplied from the DCDC converter 11 or the low voltage battery 12 to the line of the +B load 2, the ACC load 3, and IG load 4 through the low voltage system J/B 15 is referred to as IG power supply mode. However, the power supply to the low voltage system load is sometimes limited, apart from the power supply mode, due to the user setting, the voltage of low voltage battery 12, the voltage of the high voltage battery 18, and the like.

At the time of the IG power supply mode, the control signal and the power can be provided to the CPU 51 of the DCDC converter 11 from the low voltage system J/B 15. The DCDC converter 11 is started up using the power supplied from the low voltage system J/B, and can start the output with the control signal as a trigger.

The switch 17 provides a signal indicating the set position of the switch 17 to the low voltage system power supply ECU 16, the BMU 19, the high voltage system power supply ECU 21, the vehicle ECU 22, and the CPU 51 through the CAN.

The high voltage battery 18 is used as a power source of the self-vehicle. Specifically, the power accumulated in the high voltage battery 18 is supplied to a travel system inverter (not shown) through the high voltage system J/B 20, and converted from the DC power to the AC power. The self-vehicle travels when the AC power is supplied to the main power motor (not shown), and the main power motor is driven. The high voltage battery 18 also supplies power to the high voltage system load of the self-vehicle other than the main power motor through the high voltage system J/B 20.

The BMU 19 manages the high voltage battery 18. For instance, the BMU 19 monitors the state (e.g., voltage, current, temperature, etc.) of the high voltage battery 18, and provides the information indicating the monitoring result to the low voltage system power supply ECU 16, the high voltage system power supply ECU 21, the vehicle ECU 22, and the CPU 51 through the CAN.

The high voltage system J/B 20 incorporates a contactor, a relay, and the like, and switches the presence of supply of power to the DCDC converter 11 and the high voltage system load of the self-vehicle based on the control of the high voltage system power supply ECU 21.

The vehicle ECU 22 performs control of the traveling system inverter and the like (not shown).

The low voltage system power supply ECU 16, the BMU 19, the high voltage system power supply ECU 21, the vehicle ECU 22, and the CPU 51 communicate through the CAN to transmit and receive various types of information.

A case in which the nominal voltage of the low voltage battery 12 is 12 VDC will be described by way of example.

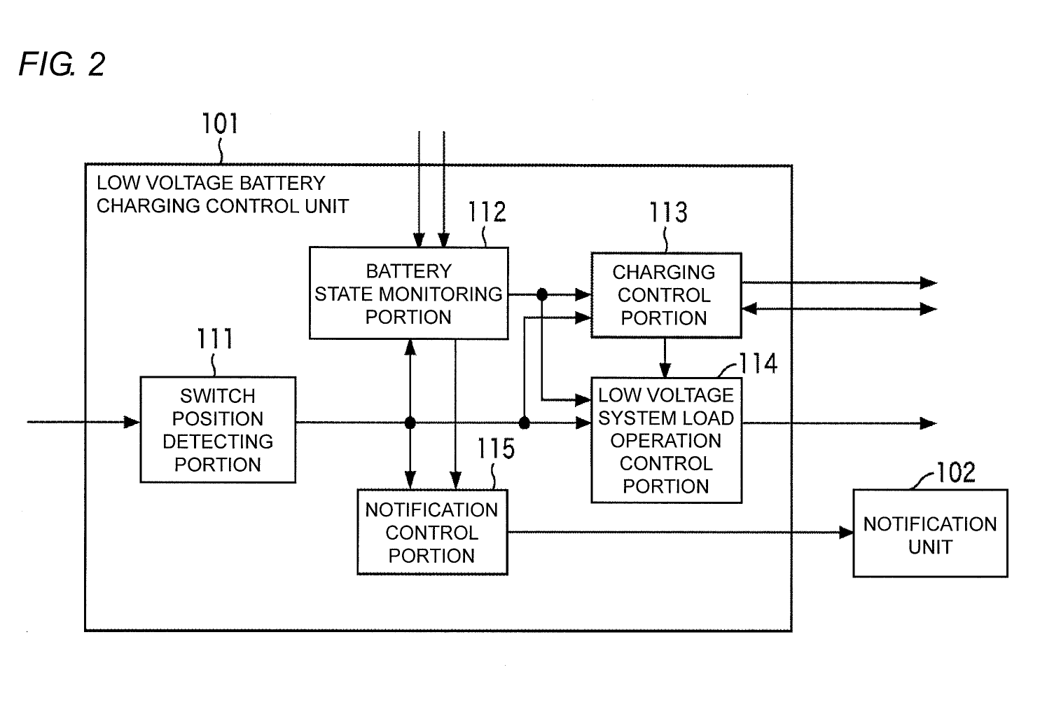

FIG. 2 is a block diagram showing one part of an example of a configuration of the function implemented when the low voltage system power supply ECU 16 and the vehicle ECU 22 execute a predetermined control program. Specifically, the function including the low voltage battery charging control unit 101 is implemented when the low voltage system power supply ECU 16 and the vehicle ECU 22 execute a predetermined control program. The low voltage battery charging control unit 101 is configured to include a switch position detecting portion 111, a battery state monitoring portion 112, a charging control portion 113, a low voltage system load operation control portion 114, and a notification control portion 115.

The switch position detecting portion 111 detects the set position of the switch 17 based on the signal from the switch 17. The switch position detecting portion 111 notifies the set position of the switch 17 to the battery state monitoring portion 112, the charging control portion 113, the low voltage system load operation control portion 114, and the notification control portion 115.

The battery state monitoring portion 112 communicates with the BMU 19, and monitors the state of the high voltage battery 18 based on the information acquired from the BMU 19. The battery state monitoring portion 112 monitors the state of the low voltage battery 12 based on the signal from the IVT sensor 13. The battery state monitoring portion 112 notifies the monitoring result of the state of the low voltage battery 12 and the high voltage battery 18 to the charging control portion 113, the low voltage system load operation control portion 114, and the notification control portion 115.

The charging control portion 113 gives a command to the CPU 51 of the DCDC converter 11 to control the output of the DCDC converter 11. The charging control portion 113 gives a command to the high voltage system power supply ECU 21, and controls the supply of power from the high voltage battery 18 to the DCDC converter 11 through the high voltage system J/B 20. Furthermore, the charging control portion 113 acquires the information related to the high voltage system load from the high voltage system power supply ECU 21.

The low voltage system load operation control portion 114 controls the low voltage system J/B 15 and controls the power supply to the low voltage system load to control the operation of the low voltage system load.

The notification control portion 115 makes a remaining amount warning of the low voltage battery 12 and the high voltage battery 18 through a notification unit 102.

The notification unit 102 is configured by a navigation system, an installment panel, a display, a lamp, an LED (Light Emitting Diode), a speaker, and the like, and makes a remaining amount warning of the low voltage battery 12 and the high voltage battery 18 with image, light, audio, and the like based on the control of the notification control portion 115. Each portion configuring the notification unit 102 is contained in one of the +B load 2, the ACC load 3, and the IG load 4.

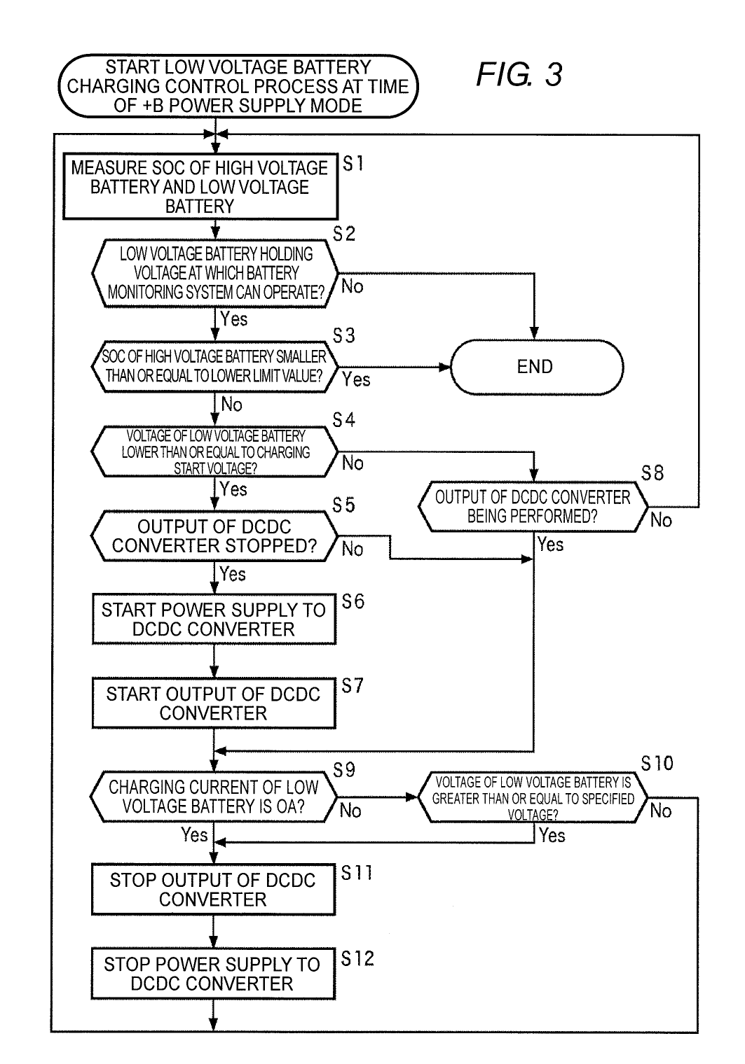

The processes executed by the electrical system 1 will now be described with reference to FIGS. 3 to 8.

The low voltage battery charging control process at the time of the +B power supply mode will be described first with reference to the flowchart of FIG. 3. The process starts when the position of the switch 17 is set to OFF, and terminates when set to other than OFF. When the position of the switch 17 is set to OFF, the switch position detecting portion 111 notifies the battery state monitoring portion 112, the charging control portion 113, the low voltage system load operation control portion 114, and the notification control portion 115 that the position of the switch 17 is set to OFF.

In step S1, the electrical system 1 measures the SOC (State of Charge, remaining capacity) of the high voltage battery 18 and the low voltage battery 12. Specifically, the battery state monitoring portion 112 gives a command to the BMU 19 to measure the SOC of the high voltage battery 18, and acquires the measurement result from the BMU 19. The battery state monitoring portion 112 measures the SOC of the low voltage battery 12 based on the voltage and the current of the low voltage battery 12 indicated by the signal from the IVT sensor 13.

The process of step S1 is executed at a predetermined interval. In other words, the state of the high voltage battery 18 and the low voltage battery 12 is intermittently monitored.

In step S2, the battery state monitoring portion 112 determines whether or not the low voltage battery 12 holds the voltage at which the operation of the battery monitoring system can operate. The battery monitoring system for monitoring the state of the high voltage battery 18 and the low voltage battery 12 is configured by the IVT sensor 13, the current sensor circuit 14, the low voltage system power supply ECU 16, the BMU 19, the high voltage system power supply ECU 21, and the like. The process proceeds to step S3 if the battery state monitoring portion 112 determines that the low voltage battery 12 holds the voltage at which the operation of the battery monitoring system can operate.

In step S3, the battery state monitoring portion 112 determines whether or not the SOC of the high voltage battery 18 is smaller than or equal to the lower limit value based on the measurement result by the BMU 19. The process proceeds to step S4 if determined that the SOC of the high voltage battery 18 is greater than the lower limit value.

The lower limit value of the SOC of the high voltage battery 18 is set to a level of the SOC minimum required to start up the engine of the self-vehicle in the case of a vehicle in which the high voltage battery 18 can be charged by a motor generator etc. during traveling such as an HEV or a PHEV, and set to a level of the SOC minimum required to charge the low voltage battery 12 using the power of the high voltage battery 18 in the case of a vehicle in which the high voltage battery 18 cannot be charged during traveling of the self-vehicle such as an EV.

In step S4, the battery state monitoring portion 112 determines whether or not the voltage of the low voltage battery 12 is lower than or equal to the charging start voltage. If determined that the voltage of the low voltage battery 12 is lower than or equal to the charging start voltage, the battery state monitoring portion 112 notifies the charging control portion 113, the low voltage system load operation control portion 114, and the notification control portion 115 that the voltage of the low voltage battery 12 is lower than or equal to the charging start voltage. The process then proceeds to step S5.

The charging start voltage is a threshold value for determining whether or not charging of the low voltage battery 12 is necessary, and is set to a value greater than the discharge end voltage of the low voltage battery 12 and slightly greater than the minimum value of the drive voltage of the low voltage system load.

In step S5, the charging control portion 113 determines whether or not the output of the DCDC converter 11 is stopped. The process proceeds to step S6 if determined that the output of the DCDC converter 11 is stopped.

In step S6, the high voltage system J/B 20 starts to supply power to the DCDC converter 11. Specifically, the charging control portion 113 gives an instruction to the high voltage system power supply ECU 21 to supply power to the DCDC converter 11. The high voltage system J/B 20 starts to supply power to the DCDC converter 11 based on the control of the high voltage system power supply ECU 21. The power then starts to be supplied from the control independent power supply circuit 35 to the control unit 36, thereby starting up the DCDC converter 11.

In step S7, the electrical system 1 starts the output of the DCDC converter 11. Specifically, the charging control portion 113 gives a command to the CPU 51 of the DCDC converter 11 to start the output of the DCDC converter 11. The DCDC converter 11 starts the output of the power (voltage and current) based on the control of the CPU 51. The low voltage battery 12 then starts to be charged. The process then proceeds to step S9.

In this case, the DCDC converter 11 first sets the output voltage to the same voltage as the low voltage battery 12, and then charges the low voltage battery 12 while controlling the output voltage so that the charging current becomes a value lower than normal (e.g., 1/10 of the current of the five hour discharge rate (five hour rate current) of the low voltage battery 12).

If determined that the output of the DCDC converter 11 is being performed in step S5, the process proceeds to step S9.

If determined that the voltage of the low voltage battery 12 is greater than the charging start voltage in step S4, the battery state monitoring portion 112 notifies the charging control portion 113, the low voltage system load operation control portion 114, and the notification control portion 115 that the voltage of the low voltage battery 12 is greater than the charging start voltage. The process then proceeds to step S8.

In step S8, the charging control portion 113 determines whether or not the output of the DCDC converter 11 is being performed. If determined that the output of the DCDC converter 11 is not being performed, that is, if the charging of the low voltage battery 12 is not being performed, the process returns to step S1, and the processes after step S1 are executed.

If determined that the output of the DCDC converter 11 is being performed in step S8, that is, if the charging of the low voltage battery 12 is being performed, the process proceeds to step S9.

In step S9, the battery state monitoring portion 112 determines whether or not the charging current of the low voltage battery 12 is OA. If determined that the charging current of the low voltage battery 12 is not OA, the process proceeds to step S10.

In step S10, the battery state monitoring portion 112 determines whether or not the voltage of the low voltage battery 12 is greater than or equal to a specified voltage. If determined that the voltage of the low voltage battery 12 is smaller than the specified voltage, the process returns to step S1, and the processes after step S1 are executed.

If determined that the voltage of the low voltage battery 12 is greater than or equal to the specified voltage in step S10, the battery state monitoring portion 112 notifies that the charging control portion 113, the low voltage system load operation control portion 114, and the notification control portion 115 that the voltage of the low voltage battery 12 is greater than or equal to the specified voltage. The process then proceeds to step S11.

The specified voltage is set to a voltage greater than the charging start voltage by a predetermined value (e.g., 1.0 V), or a full-charging voltage of the low voltage battery 12.

If determined that the charging current of the low voltage battery 12 is OA in step S9, the battery state monitoring portion 112 notifies the charging control portion 113, the load voltage system load operation control portion 114, and the notification control portion 115 that the charging current of the low voltage battery 12 is OA. The process of step S10 is then skipped, and the process proceeds to step S11.

This is a case in which the input voltage to the DCDC converter 11 lowers with lowering the SOC of the high voltage battery 18, and the charging current cannot be supplied from the DCDC converter 11 to the low voltage battery 12.

In step S11, the electrical system 1 stops the output of the DCDC converter 11. Specifically, the charging control portion 113 gives an instruction to stop the output to the CPU 51 of the DCDC converter 11. The DCDC converter 11 stops the output of the power (voltage and current) based on the control of the CPU 51. The charging of the low voltage battery 12 thereby stops.

In step S12, the high voltage system J/B 20 stops the power supply to the DCDC converter 11. Specifically, the charging control portion 113 gives an instruction to the high voltage system power supply ECU 21 to stop the power supply to the DCDC converter 11. The high voltage system J/B 20 stops the power supply to the DCDC converter 11 based on the control of the high voltage system power supply ECU 21. The DCDC converter 11 then stops. The process then returns to step S1, and the processes after step S1 are executed.

If determined that the low voltage battery 12 does not hold the voltage at which the operation of the battery monitoring system can operate in step S2, or if determined that the SOC of the high voltage battery 18 is lower than or equal to the lower limit value in step S3, the low voltage battery charging control process is terminated.

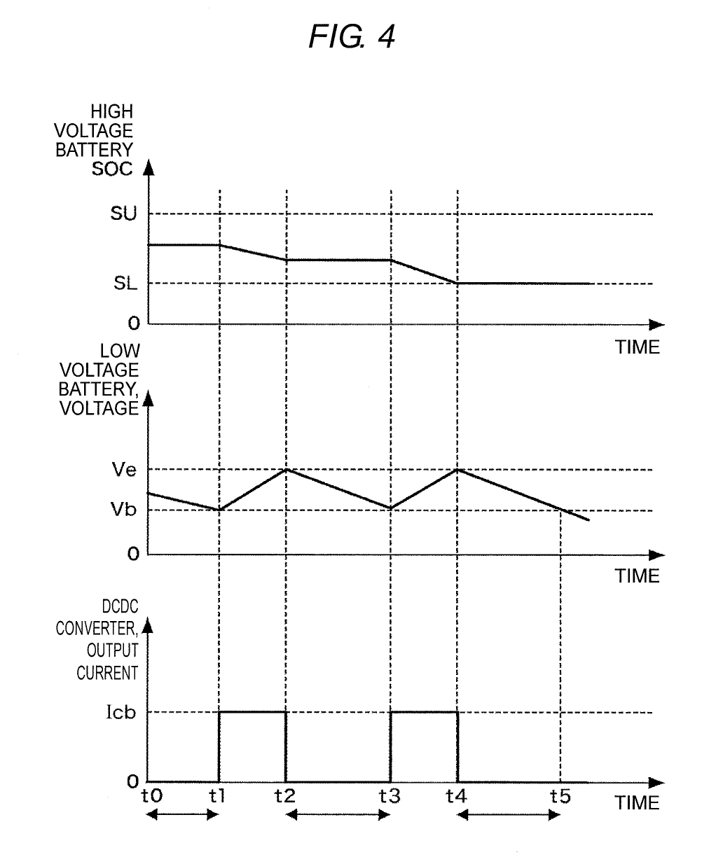

An example of the time-series transition of the SOC of the high voltage battery 18, the voltage of the low voltage battery 12, and the output current of the DCDC converter 11 at the time of the +B power supply mode will now be described with reference to FIG. 4. The uppermost graph in FIG. 4 shows the time-series transition of the SOC of the high voltage battery 18, the graph second from the top shows the time-series transition of the voltage of the low voltage battery 12, and the lowermost graph shows the time-series transition of the output current of the DCDC converter 11. In the graph of the SOC of the high voltage battery 18, SU indicates the upper limit value of the SOC of the high voltage battery 18, and SL indicates the lower limit value of the SOC of the high voltage battery 18.

From time t0 to time t1, the power of the low voltage battery 12 is consumed by the +B load 2 but the charging of the low voltage battery 12 is not performed, and thus the voltage of the low voltage battery 12 lowers. In this case, the high voltage system load is not operating and the power of the high voltage battery 18 is not consumed, and thus the SOC of the high voltage battery 18 barely changes.

At time t1, the output of the DCDC converter 11 starts and the charging of the low voltage battery 12 starts when the voltage of the low voltage battery 12 reaches the charging start voltage Vb. In this case, the output current of the DCDC converter 11 is controlled to be maintained at Icb (e.g., 1/10 of five hour rate current of the low voltage battery 12). The SOC of the high voltage battery 18 reduces during the charging of the low voltage battery 12 since the power of the high voltage battery 18 is used for the charging of the low voltage battery 12. Thereafter, at time t2, the output of the DCDC converter 11 is stopped and the charging of the low voltage battery 12 is stopped when the voltage of the low voltage battery 12 returns to the specified voltage Ve.

Similarly, from time t2 to time t3, the power of the low voltage battery 12 is consumed by the +B load 2 but the charging of the low voltage battery 12 is not performed, and thus the voltage of the low voltage battery 12 lowers. Furthermore, the SOC of the high voltage battery 18 barely changes since the power of the high voltage battery 18 is not consumed. At time t3, the output of the DCDC converter 11 starts and the charging of the low voltage battery 12 starts when the voltage of the low voltage battery 12 reaches the charging start voltage Vb, and at time t4, the output of the DCDC converter 11 is stopped and the charging of the low voltage battery 12 is stopped when the voltage of the low voltage battery 12 returns to the specified voltage Ve.

As shown in the figure, the charging of the low voltage battery 12 is not performed even if the voltage of the low voltage battery 12 reaches the charging start voltage Vb at time t5 after the SOC of the high voltage battery 18 becomes lower than or equal to the lower limit value SL at time t4.

Therefore, the SOC of the low voltage battery 12 is intermittently monitored and charging is automatically performed during the lowering of the voltage of the low voltage battery 12 while set to a state in which the +B power supply mode is set, the power supply to the ACC load 3 and the IG load 4 other than the +B load 2 is stopped, the DCDC converter 11 is stopped and the self-vehicle cannot travel. Thus, the low voltage battery 12 is prevented from running out even when the self-vehicle is left parking for a long period. As a result, cases in which the control system including the ECU does not operate, for example, traveling is disabled, the normal charging of the low voltage battery 12 and the high voltage battery 18 cannot be performed, or failure diagnosis of the vehicle accessory and the failure diagnosis using a tester are prevented.

The low voltage battery 12 is charged only during the lowering of the voltage and the power supply to the DCDC converter 11 is normally stopped, so that the power of the high voltage battery 18 is prevented from being wastefully consumed by discharge resistor (not shown) and the like arranged in the high voltage system.

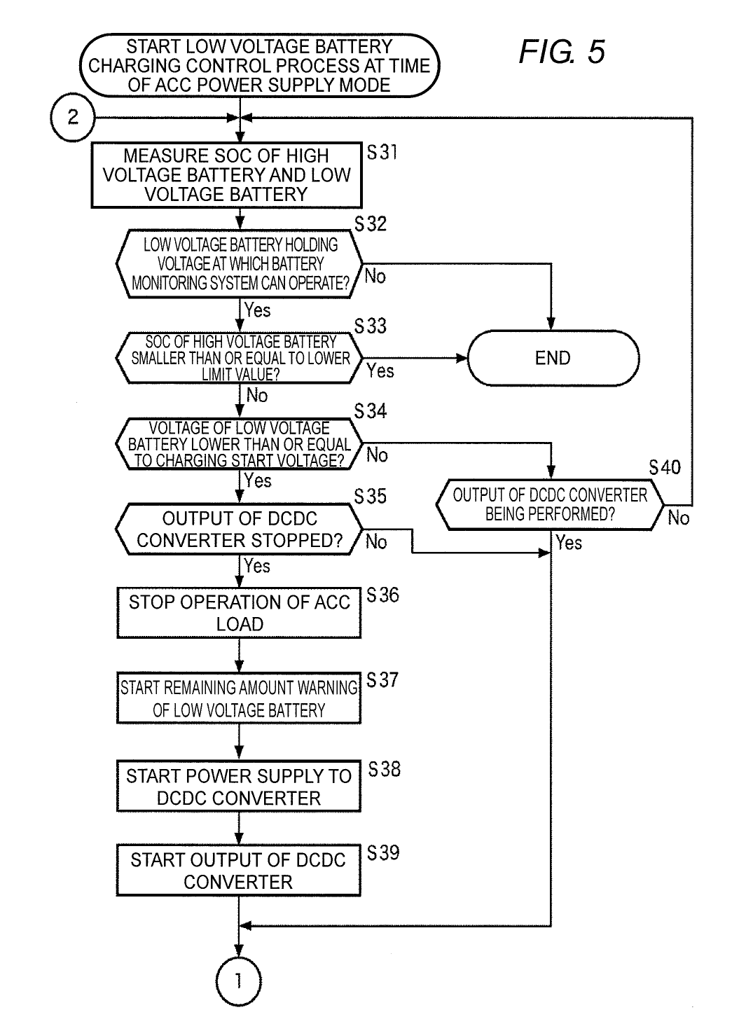

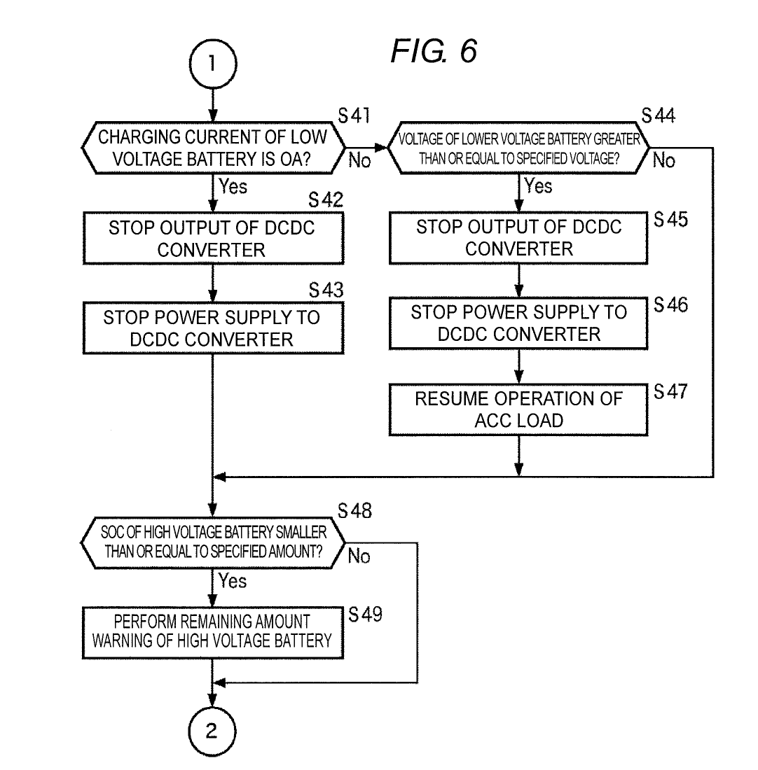

The low voltage battery charging control process at the time of ACC power supply mode will now be described with reference to the flowcharts of FIGS. 5 and 6. The process starts when the position of the switch 17 is set to ACC, and terminates when set to other than ACC. When the position of the switch 17 is set to ACC, the switch position detecting portion 111 notifies the battery state monitoring portion 112, the charging control portion 113, the low voltage system load operation control portion 114, and the notification control portion 115 that the position of the switch 17 is set to ACC.

Similar to the process of step S1 of FIG. 3, in step S31, the electrical system 1 measures the SOC of the high voltage battery 18 and the low voltage battery 12. In other words, the states of the high voltage battery 18 and the low voltage battery 12 are intermittently monitored.

Similar to the process of step S2 of FIG. 3, in step S32, whether or not the low voltage battery 12 holds the voltage at which the operation of the battery monitoring system can operate is determined, and the process proceeds to step S33 if determined that the low voltage battery 12 holds the voltage at which the operation of the battery monitoring system can operate.

Similar to the process of step S3 of FIG. 3, in step S33, whether or not the SOC of the high voltage battery 18 is smaller than or equal to the lower limit value is determined, and the process proceeds to step S34 if determined that the SOC of the high voltage battery 18 is greater than the lower limit value.

Similar to the process of step S4 of FIG. 3, in step S34, whether or not the voltage of the low voltage battery 12 is lower than or equal to the charging start voltage is determined, and the process proceeds to step S35 if determined that the voltage of the low voltage battery 12 is lower than or equal to the charging start voltage.

Similar to the process of step S5 of FIG. 3, in step S35, whether or not the output of the DCDC converter 11 is stopped is determined, and the process proceeds to step S36 if determined that the output of the DCDC converter 11 is stopped.

In step S36, the low voltage system load operation control portion 114 stops the operation of the ACC load 3. Specifically, the low voltage system J/B 15 stops the power supply to the ACC load 3 based on the control of the low voltage system load operation control portion 114. The operation of the ACC load 3 thereby stops. The power supply to one part of the ACC load 3 may be stopped to stop the operation of only one part of the ACC load 3 according to the priority set in advance by user setting and the like without stopping the power supply to all the ACC load 3. The low voltage system load operation control portion 114 may directly give an instruction to each ACC load 3 to stop the operation.

In step S37, the notification unit 102 makes a remaining amount warning of the low voltage battery 12 based on the control of the notification control portion 115. For instance, the notification unit 102 warns that the voltage of the low voltage battery 12 lowered, the low voltage battery 12 is being charged, and the operation of the ACC load 3 is stopped through methods such as displaying a warning screen on the display, lighting or flashing the LED, the lamp, etc., outputting an audio guidance, and ringing a warning sound based on the control of the notification control portion 115. In the case of a vehicle in which the high voltage battery 18 can be charged during traveling such as an HEV or a PHEV, the notification unit 102 starts up the engine to travel, and also makes a notification to urge a supplementary charging of the high voltage battery 18. The remaining amount warning is stopped when the driver performs the stop operation or when the voltage of the low voltage battery 12 becomes greater than or equal to the specified voltage, to be described later.

Similar to the process of step S6 of FIG. 3, in step S38, the power starts to be supplied to the DCDC converter 11, and in step S39, the output of the DCDC converter 11 starts and the low voltage battery 12 starts to be charged, similar to the process of step S7 of FIG. 3. The process then proceeds to step S41.

In this case, the DCDC converter 11 first sets the output voltage to the same voltage as the low voltage battery 12, and then charges the low voltage battery 12 while controlling the output voltage so that the charging current becomes a value lower than normal and higher than at the time of the +B power supply mode (e.g., ⅕ to ½ of the five hour rate current of the low voltage battery 12).

If determined that the output of the DCDC converter 11 is being performed in step S35, the process proceeds to step S41.

If determined that the voltage of the low voltage battery 12 is greater than the charging start voltage in step S34, the process proceeds to step S40.

Similar to the process of step S8 of FIG. 3, in step S40, whether or not the output of the DCDC converter 11 is being performed is determined, and if determined that the output of the DCDC converter 11 is not being performed, the process returns to step S1, and the processes after step S1 are executed.

If determined that the output of the DCDC converter 11 is being performed in step S40, the process proceeds to step S41.

Similar to the process of step S9 of FIG. 3, in step S41, whether or not the charging current of the low voltage battery 12 is OA is determined, and the process proceeds to step S42 if determined that the charging current of the low voltage battery 12 is OA.

Similar to the process of step S11 of FIG. 3, in step S42, the output of the DCDC converter 11 is stopped so that the charging of the low voltage battery 12 is stopped, and in step S43, the power supply to the DCDC converter 11 is stopped, similar to the process of step S12 of FIG. 3. The process then proceeds to step S48.

If determined that the charging current of the low voltage battery 12 is not OA in step S41, the process proceeds to step S44.

Similar to the process of step S10 of FIG. 3, in step S44, whether or not the voltage of the low voltage battery 12 is greater than or equal to a specified voltage is determined, and the process proceeds to step S45 if determined that the voltage of the low voltage battery 12 is greater than or equal to the specified voltage.

Similar to the process of step S11 of FIG. 3, in step S45, the output of the DCDC converter 11 is stopped and the charging of the low voltage battery 12 is stopped, and in step S46, the power supply to the DCDC converter 11 is stopped, similar to the process of step S12 of FIG. 3.

In step S47, the low voltage system load operation control portion 114 stops the operation of the ACC load 3. Specifically, the low voltage system J/B 15 resumes the power supply to the ACC load 3 based on the control of the low voltage system load operation control portion 114. The operation of the ACC load 3 then resumes. For instance, the low voltage system load operation control portion 114 may directly give an instruction to each ACC load 3 to resume the operation. The process then proceeds to step S48.

If determined that the voltage of the low voltage battery 12 is smaller than the specified voltage in step S44, the processes of steps S45 to S47 are skipped and the process proceeds to step S48.

In step S48, the battery state monitoring portion 112 determined whether or not the SOC of the high voltage battery 18 is smaller than or equal to the specified amount (e.g., amount the self-vehicle is estimated to travel a predetermined distance (e.g., 50 km) or more) based on the measurement result of the BMU 19. If determined that the SOC of the high voltage battery 18 is smaller than or equal to the specified amount, the battery state monitoring portion 112 notifies this to the notification control portion 115. The process then proceeds to step S49.

In step S49, the notification unit 102 makes a remaining amount warning of the high voltage battery 18 based on the control of the notification control portion 115. For instance, the notification unit 102 warns that the remaining amount of the high voltage battery 18 is small and urges the charging of the high voltage battery 18 through methods such as displaying a warning screen on the display, lighting or flashing the LED, the lamp, etc., outputting an audio guidance, and ringing a warning sound based on the control of the notification control portion 115. The remaining amount warning is stopped when the driver performs the stop operation or when the SOC of the high voltage battery 18 becomes greater than the specified amount. The process then returns to step S31, and the processes after step S31 are executed.

If determined that the SOC of the high voltage battery 18 is greater than the specified amount in step S48, the process returns to step S31 and the processes after step S31 are executed.

In the case of a vehicle including a different power source other than the high voltage battery 18 such as an HEV or a PHEV, the processes of steps S48 and S49 can be omitted.

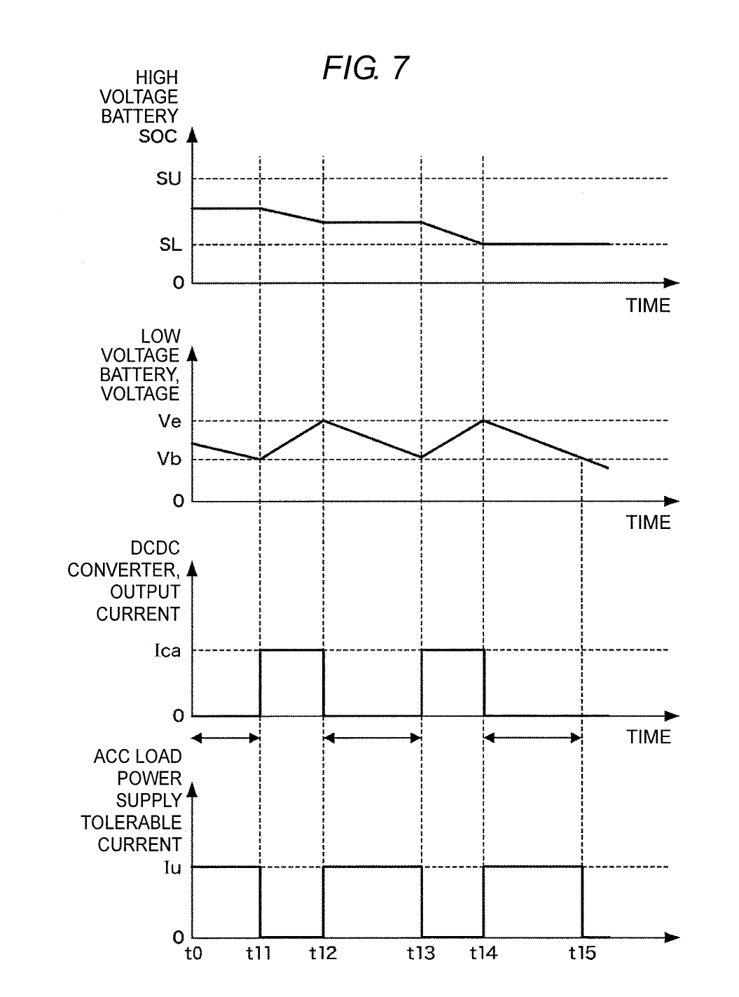

An example of the time-series transition of the SOC of the high voltage battery 18, the voltage of the low voltage battery 12, the output current of the DCDC converter 11, and the ACC load power supply tolerable current at the time of the ACC power supply mode will now be described with reference to FIG. 7. The uppermost graph in FIG. 7 shows the time-series transition of the SOC of the high voltage battery 18, the graph second from the top shows the time-series transition of the voltage of the low voltage battery 12, the graph third from the top shows the time-series transition of the output current of the DCDC converter 11, and the lowermost graph shows the time-series transition of the ACC load power supply tolerable current. The ACC load power supply tolerable current defines the maximum value of current that can be supplied to the ACC load 3.

From time t0 to time t11, the ACC load power supply tolerable current is set to an upper limit value lu, the power of the low voltage battery 12 is consumed by the +B load 2 and the ACC load 3 but the charging of the low voltage battery 12 is not performed, and thus the voltage of the low voltage battery 12 lowers. In this case, the high voltage system load is not operating and the power of the high voltage battery 18 is not consumed, and thus the SOC of the high voltage battery 18 barely changes.

At time t11, the output of the DCDC converter 11 starts and the charging of the low voltage battery 12 starts when the voltage of the low voltage battery 12 reaches the charging start voltage Vb. In this case, the output current of the DCDC converter 11 is controlled to be maintained at Ica (e.g., ⅕ to ½ of five hour rate current of the low voltage battery 12). The ACC load power supply tolerable current is set to 0, and the power supply to the ACC load 3 is stopped. The SOC of the high voltage battery 18 reduces during the charging of the low voltage battery 12 since the power of the high voltage battery 18 is used for the charging of the low voltage battery 12.

Thereafter, at time t12, the output of the DCDC converter 11 is stopped and the charging of the low voltage battery 12 is stopped when the voltage of the low voltage battery 12 returns to the specified voltage Ve. The ACC load power supply tolerable current is set to the upper limit value lu, and the power supply to the ACC load 3 is resumed.

Similarly, from time t12 to time t13, the power of the low voltage battery 12 is consumed by the +B load 2 and the ACC load 3 but the charging of the low voltage battery 12 is not performed, and thus the voltage of the low voltage battery 12 lowers. The SOC of the high voltage battery 18 barely changes since the power of the high voltage battery 18 is not consumed. At time t13, the output of the DCDC converter 11 starts, the charging of the low voltage battery 12 starts, the ACC load power supply tolerable current is set to 0, and the power supply to the ACC load 3 is stopped when the voltage of the low voltage battery 12 reaches the charging start voltage Vb. Thereafter, at time t14, the output of the DCDC converter 11 is stopped, the charging of the low voltage battery 12 is stopped, the ACC load power supply tolerable current is set to the upper limit value lu, and the power supply to the ACC load 3 is resumed when the voltage of the low voltage battery 12 returns to the specified voltage Ve.

As shown in the figure, the ACC load power supply tolerable current is set to 0 and the power supply to the ACC load 3 is stopped but the charging of the low voltage battery 12 is not performed even if the voltage of the low voltage battery 12 reaches the charging start voltage Vb at time t15 after the SOC of the high voltage battery 18 becomes lower than or equal to the lower limit value SL at time t14.

Therefore, the SOC of the low voltage battery 12 is intermittently monitored and charging is automatically performed during the lowering of the voltage of the low voltage battery 12 while set to a state in which ACC power supply mode is set, the power can be supplied to the ACC load 3 in addition to the +B load 2, the DCDC converter 11 is stopped and the self-vehicle cannot travel. Thus, the load of the accessories such as the car audio becomes large during the ACC power supply mode, and the low voltage battery 12 is prevented from running out even if a state in which the power of the low voltage battery 12 is consumed in great amount is continued. As a result, cases in which the control system including the ECU does not operate, for example, traveling is disabled, the normal charging of the low voltage battery 12 and the high voltage battery 18 cannot be performed, or failure diagnosis of the vehicle accessory and the failure diagnosis using a tester cannot be made are prevented.

The low voltage battery 12 is charged only during the lowering of the voltage and the power supply to the DCDC converter 11 is normally stopped, so that the power of the high voltage battery 18 is prevented from being wastefully consumed by discharge resistor (not shown) and the like arranged in the high voltage system.

The operation of the ACC load 3 is stopped and the charging current is set larger than at the time of the +B power supply mode at the time of the lowering of the voltage of the low voltage battery 12, so that the low voltage battery 12 can be charged faster and the use of the ACC load 3 can be resumed.

The low voltage battery 12 is more reliably prevented from running out by making a remaining amount warning and calling the attention of the driver.

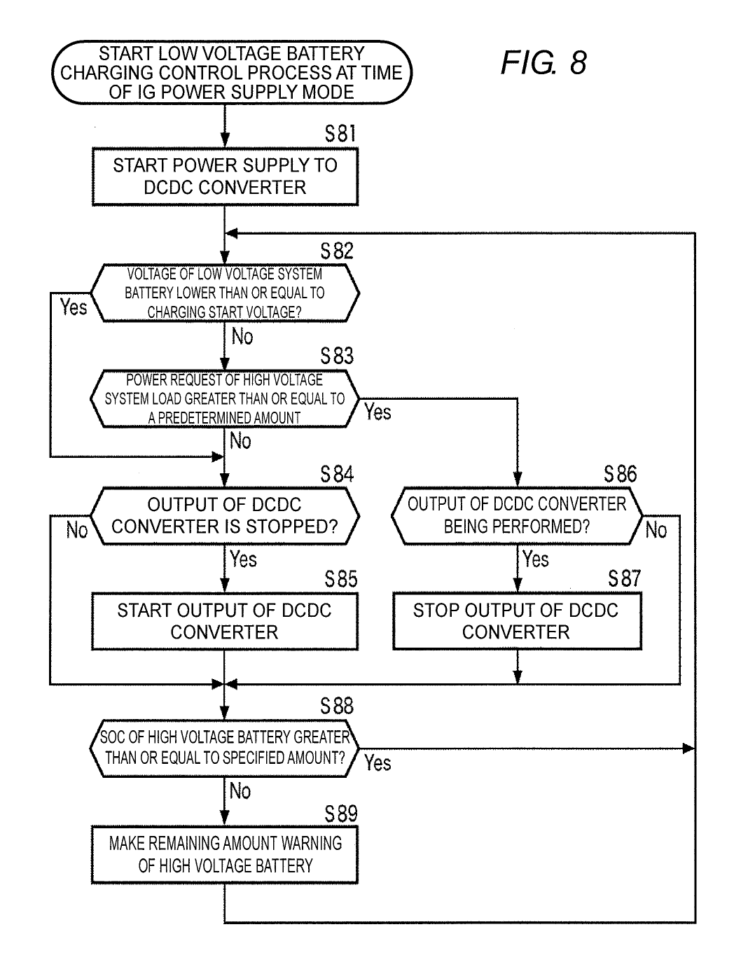

The low voltage battery charging control process at the time of IG power supply mode will now be described with reference to the flowchart of FIG. 8. The process starts when the position of the switch 17 is set to IG or START, and terminates when set to other than IG and START. When the position of the switch 17 is set to IG or START, the switch position detecting portion 111 notifies the battery state monitoring portion 112, the charging control portion 113, the low voltage system load operation control portion 114, and the notification control portion 115 that the position of the switch 17 is set to IG or START.

Similar to the process of step S6 of FIG. 3, in step S81, the power starts to be supplied to the DCDC converter 11.

Similar to the process of step S4 of FIG. 3, in step S82, whether or not the voltage of the low voltage battery 12 is lower than or equal to the charging start voltage is determined, and the process proceeds to step S83 if determined that the voltage of the low voltage battery 12 is greater than the charging start voltage.

In step S83, the charging control portion 113 determines whether or not the power request of the high voltage system load is greater than or equal to a predetermined amount based on the information from the high voltage system power supply ECU 21. The process proceeds to step S84 if determined that the power request of the high voltage system load is not greater than or equal to a predetermined amount.

If determined that the voltage of the low voltage battery 12 is smaller than or equal to the charging start voltage in step S82, the process of step S83 is skipped and the process proceeds to step S84.

Similar to the process of step S5 of FIG. 3, in step S84, whether or not the output of the DCDC converter 11 is stopped is determined, and the process proceeds to step S85 if determined that the output of the DCDC converter 11 is stopped.

Similar to the process of step S7 of FIG. 3, in step S85, the output of the DCDC converter 11 starts and the low voltage battery 12 starts to be charged. The process then proceeds to step S88.

If determined that the output of the DCDC converter 11 is being performed in step S84, the process proceeds to step S88.

If determined that the power request of the high voltage system load is greater than or equal to the predetermined amount in step S83, the process proceeds to step S86.

Similar to the process of step S8 of FIG. 3, in step S86, whether or not the output of the DCDC converter 11 is being performed is determined, and if determined that the output of the DCDC converter 11 is being performed, the process proceeds to step S87.

Similar to the process of step S11 of FIG. 3, in step S87, the output of the DCDC converter 11 is stopped so that the charging of the low voltage battery 12 is stopped. The process then proceeds to step S88.

If determined that the output of the DCDC converter 11 is stopped in step S86, the process of step S87 is skipped, and the process proceeds to step S88.

Similar to the process of step S48 of FIG. 6, in step S88, whether or not the SOC of the high voltage battery 18 is greater than or equal to the specified amount is determined, and the process proceeds to step S89 if determined that the SOC of the high voltage battery 18 is smaller than the specified amount.

Similar to the process of step S49 of FIG. 4, in step S89, a remaining amount warning of the high voltage battery 18 is made. If the self-vehicle is an HEV or a PHEV, the mode may transition to the traveling mode only with the engine without using the high voltage battery 18. The process then returns to step S82, and the processes after step S82 are executed.

If determined that the SOC of the high voltage battery 18 is greater than or equal to the specified amount in step S88, the process returns to step S82, and the processes after step S82 are executed.

In the case of a vehicle including a different power source other than the high voltage battery 18 such as an HEV or a PHEV, the processes of steps S88 and S89 can be omitted.

Therefore, at the time of the IG power supply mode, the output of the DCDC converter 11 is performed and the low voltage battery 12 is charged when the power request of the high voltage system load is smaller than the predetermined amount or when the voltage of the low voltage battery 12 is smaller than or equal to the charging start voltage. When the power request of the high voltage system load becomes greater than or equal to the predetermined amount such as at the time of acceleration, the output of the DCDC converter 11 is stopped and the charging of the low voltage battery 12 is temporarily stopped unless the voltage of the low voltage battery 12 is smaller than or equal to the charging start voltage. In other words, the charging of the low voltage battery 12 is controlled according to the capacity of the high voltage system load, and the charging of the low voltage battery 12 is preferentially performed regardless of the capacity of the high voltage system load during the lowering of voltage of the low voltage battery 12.

The function of the low voltage battery charging control unit 101 may be loaded in the DCDC converter 11 or the low voltage battery 12.

The series of processes of the low voltage battery charging control unit 101 may be executed by hardware.

When executing the process of the low voltage battery charging control unit 101 by software, the program for implementing the process of the low voltage battery charging control unit 101 may be installed in advance in a recording medium (not shown) of the electrical system 1, or may be recorded in a removable media or a package media including a magnetic disc (include a flexible disc), an optical disc (CD-ROM (Compact Disc-Read Only Memory), DVD (Digital Versatile Disc) etc.), a magnetic optical disc, or a semiconductor memory and provided and installed through wired or wireless transmission medium such as local area network, Internet, and digital satellite broadcasting.

The program for implementing the process of the low voltage battery charging control unit 101 may be a program in which the processes are performed in time-series along the order described in the specification, or may be a program in which the processes are performed in parallel or at the necessary timing when callout is made, or the like.

The embodiments of the present invention are not limited to the above-described embodiments, and various modifications may be made within a scope not deviating from the gist of the invention.

In accordance with one aspect of the present invention, a charging control device for controlling charging of a second battery, charged by a power output from a voltage conversion unit for converting a voltage of a first battery as a power source of a vehicle, and supplying power to electrical components arranged in the vehicle; the charging control device includes: a monitoring portion for intermittently monitoring the voltage of the second battery while power supply to the electrical components other than a first load, which is constantly supplied with power of the electrical components, is stopped, the voltage conversion unit is stopped, and a first state in which the vehicle cannot travel is set; and a charging control portion for starting up the voltage conversion unit and controlling to charge the second battery with the power of the first battery through the voltage conversion unit when the voltage of the second battery becomes smaller than or equal to a predetermined threshold value while set in the first state.

In the charging control device of one aspect of the present invention, the voltage of the second battery is intermittently monitored while the power supply to the electrical components other than the first load, which is constantly supplied with power of the electrical components arranged in the vehicle, is stopped, the voltage conversion unit is stopped, and the first state in which the vehicle cannot travel is set; and the voltage conversion unit is started up and the second battery is charged by the power of the first battery through the voltage conversion unit when the voltage of the second battery becomes lower than or equal to a predetermined threshold value while set in the first state.

Therefore, the second battery is reliably prevented from running out.

The vehicle is configured by an electric vehicle such as an EV (Electric Vehicle), an HEV (Hybrid Electric Vehicle), and a PHEV (Plug-in Hybrid Electric Vehicle). The first battery and the second battery are configured by a secondary battery such as a lead accumulator, a lithium ion battery, and a nickel-hydrogen battery. The voltage conversion unit is configured by a DCDC converter, for example. The monitoring portion and the charging control portion are configured by a CPU (Central Processing Unit), or an ECU (Electronic Control Unit).

In accordance with one aspect of the present invention, a charging control method includes the step in which a charging control device, which controls charging of a second battery, charged by a power output from a voltage conversion unit for converting a voltage of a first battery as a power source of a vehicle, and supplying power to electrical components arranged in the vehicle, intermittently monitors the voltage of the second battery while power supply to the electrical components other than a first load, which is constantly supplied with power of the electrical components, is stopped, the voltage conversion unit is stopped, and a first state in which the vehicle cannot travel is set; and starts up the voltage conversion unit and controls to charge the second battery with the power of the first battery through the voltage conversion unit when the voltage of the second battery becomes smaller than or equal to a predetermined threshold value while set in the first state.

Therefore, the second battery is reliably prevented from running out.

The operation control portion is configured by a CPU (Central Processing Unit), or an ECU (Electronic Control Unit).

A battery diagnosis method of a first aspect of the present invention includes the step in which a charging control device, which controls charging of a second battery, charged by a power output from a voltage conversion unit for converting a voltage of a first battery as a power source of a vehicle, and supplying power to an electrical component arranged in the vehicle, intermittently monitors a voltage of the second battery while power supply to the electrical components other than a first load, which is constantly supplied with power of the electrical components, is stopped, the voltage conversion unit is stopped, and a first state in which the vehicle cannot travel is set; and starts up the voltage conversion unit and controls to charge the second battery with the power of the first battery through the voltage conversion unit when the voltage of the second battery becomes smaller than or equal to a predetermined threshold value while set in the first state.

In accordance with one aspect of the present invention, a program causes a computer, which controls charging of a second battery, charged by a power output from a voltage conversion unit for converting a voltage of a first battery as a power source of a vehicle, and supplying power to electrical components arranged in the vehicle, to execute processes including the steps of: intermittently monitoring the voltage of the second battery while power supply to the electrical components other than a first load, which is constantly supplied with power of the electrical components, is stopped, the voltage conversion unit is stopped, and a first state in which the vehicle cannot travel is set; and starting up the voltage conversion unit and controlling to charge the second battery with the power of the first battery through the voltage conversion unit when the voltage of the second battery becomes smaller than or equal to a predetermined threshold value while set in the first state.

In the charging control method of the first aspect of the present invention, or the computer for executing the program of the first aspect of the present invention, the voltage of the second battery is intermittently monitored while the power supply to the electrical components other than the first load, which is constantly supplied with power of the electrical components arranged in the vehicle, is stopped, the voltage conversion unit is stopped, and the first state in which the vehicle cannot travel is set; and the voltage conversion unit is started up and the second battery is charged by the power of the first battery through the voltage conversion unit when the voltage of the second battery becomes lower than or equal to a predetermined threshold value while set in the first state.

Therefore, the second battery is reliably prevented from running out.

The vehicle is configured by an electric vehicle such as an EV (Electric Vehicle), an HEV (Hybrid Electric Vehicle), and a PHEV (Plug-in Hybrid Electric Vehicle). The first battery and the second battery are configured by a secondary battery such as a lead accumulator, a lithium ion battery, and a nickel-hydrogen battery. The voltage conversion unit is configured by a DCDC converter. The charging control device is configured by a CPU (Central Processing Unit), or an ECU (Electronic Control Unit).

In accordance with one aspect of the present invention, a charging device includes: a voltage conversion unit for converting a voltage of a first battery as a power source of a vehicle; a monitoring portion for intermittently monitoring a voltage of a second battery while power supply to electrical components other than a first load, which is constantly supplied with power of the electrical components supplied with power from the second battery charged by the power output from the voltage conversion unit, is stopped, the voltage conversion unit is stopped, and a first state in which the vehicle cannot travel is set; and a charging control portion for starting up the voltage conversion unit and controlling to charge the second battery with the power of the first battery through the voltage conversion unit when the voltage of the second battery becomes smaller than or equal to a predetermined threshold value while set in the first state.

In the charging device of the second aspect of the present invention, the voltage of the second battery is intermittently monitored while the power supply to the electrical components other than the first load, which is constantly supplied with power of the electrical components supplied with power from the second battery charged by the power output from the voltage conversion unit for converting the battery of the first battery or the power source of the vehicle, arranged in the vehicle, is stopped, the voltage conversion unit is stopped, and the first state in which the vehicle cannot travel is set; and the voltage conversion unit is started up and the second battery is charged by the power of the first battery through the voltage conversion unit when the voltage of the second battery becomes lower than or equal to a predetermined threshold value while set in the first state.

Therefore, the second battery is reliably prevented from running out.

The vehicle is configured by an electric vehicle such as an EV (Electric Vehicle), an HEV (Hybrid Electric Vehicle), and a PHEV (Plug-in Hybrid Electric Vehicle). The first battery and the second battery are configured by a secondary battery such as a lead accumulator, a lithium ion battery, and a nickel-hydrogen battery. The voltage conversion unit is configured by a DCDC converter. The monitoring portion and the charging control portion are configured by a CPU (Central Processing Unit), or an ECU (Electronic Control Unit).

According to the first aspect or the second aspect of the present invention, the battery for supplying power to the electrical components arranged in the electric vehicle can be charged. In particular, according to the first aspect or the second aspect of the present invention, the battery for supplying power to the electrical components arranged in the electric vehicle can be reliably prevented from running out.

What is claimed is:

1. A charging control device for controlling charging of a second battery, charged by a power output from a voltage conversion unit for converting a voltage of a first battery as a power source of a vehicle, and supplying power to electrical components arranged in the vehicle; the charging control device comprising:
a monitoring portion for intermittently monitoring the voltage of the second battery while power supply to the electrical components other than a first load, which is constantly supplied with power of the electrical components, is stopped, the voltage conversion unit is stopped, and a first state in which the vehicle cannot travel is set; and
a charging control portion for starting up the voltage conversion unit and controlling to charge the second battery with the power of the first battery through the voltage conversion unit when the voltage of the second battery becomes smaller than or equal to a predetermined threshold value while set in the first state.

2. The charging control device according to claim 1, wherein
the monitoring portion intermittently monitors the voltage of the second battery while power is suppliable to a second load including one part of the electrical components other than the first load, the voltage conversion unit is stopped, and a second state in which the vehicle cannot travel is set;
the charging control portion starts up the voltage conversion unit and controls to charge the second battery with the power of the first battery through the voltage conversion unit when the voltage of the second battery becomes smaller than or equal to the threshold value while set in the second state; and an operation control portion for stopping the operation of at least one part of the second load when the voltage of the second battery becomes smaller than or equal to the threshold value while set in the second state is further arranged.

3. A charging control method comprising the step in which a charging control device, which controls charging of a second battery, charged by a power output from a voltage conversion unit for converting a voltage of a first battery as a power source of a vehicle, and supplying power to electrical components arranged in the vehicle,
intermittently monitors the voltage of the second battery while power supply to the electrical components other than a first load, which is constantly supplied with power of the electrical components, is stopped, the voltage conversion unit is stopped, and a first state in which the vehicle cannot travel is set; and
starts up the voltage conversion unit and controls to charge the second battery with the power of the first battery through the voltage conversion unit when the voltage of the second battery becomes smaller than or equal to a predetermined threshold value while set in the first state.

4. A program for causing a computer, which controls charging of a second battery, charged by a power output from a voltage conversion unit for converting a voltage of a first battery as a power source of a vehicle, and supplying power to electrical components arranged in the vehicle, to execute processes including the steps of:
intermittently monitoring the voltage of the second battery while power supply to the electrical components other than a first load, which is constantly supplied with power of the electrical components, is stopped, the voltage conversion unit is stopped, and a first state in which the vehicle cannot travel is set; and
starting up the voltage conversion unit and controlling to charge the second battery with the power of the first battery through the voltage conversion unit when the voltage of the second battery becomes smaller than or equal to a predetermined threshold value while set in the first state.

5. A charging device comprising:
a voltage conversion unit for converting a voltage of a first battery as a power source of a vehicle;
a monitoring portion for intermittently monitoring a voltage of a second battery while power supply to electrical components other than a first load, which is constantly supplied with power of the electrical components supplied with power from the second battery charged by the power output from the voltage conversion unit, is stopped, the voltage conversion unit is stopped, and a first state in which the vehicle cannot travel is set; and
a charging control portion for starting up the voltage conversion unit and controlling to charge the second battery with the power of the first battery through the voltage conversion unit when the voltage of the second battery becomes smaller than or equal to a predetermined threshold value while set in the first state.
